(19) United States
(12) Patent Application Publication
(10) Pub. No.: US 2024/0336524 A1
(43) Pub. Date: Oct. 10, 2024

(54) Spray-Applicable Joint Tape for Drywall Constructions

(71) Applicant: Knauf Gips KG, Iphofen (DE)

(72) Inventors: Caroline Gambichler, Kirchschönbach (DE); Gabriel Schoeneich, Kürnach (DE); Stephan Dietz, Pretzfeld (DE); Herbert Friederich, Mainbernheim (DE); Ioan Ardelean, Dachsbach (DE)

(21) Appl. No.: 18/574,892

(22) PCT Filed: Jul. 2, 2021
(86) PCT No.: PCT/EP2021/000077

§ 371 Date: Dec. 28, 2023

(51) Int. Cl. C04B 16/02; C04B 22/00; C04B 24/16; C04B 26/04; C04B 103/44; C04B 111/00

(52) U.S. Cl. CPC C04B 16/02; C04B 22/002; C04B 24/168; C04B 26/04; C04B 2103/44; C04B 2111/00146; C04B 2111/00689; C04B 2201/50

(57) ABSTRACT

A mixture for covering joints between building boards in drywall constructions, which can be applied by spraying, wherein the mixture contains 0.01 to 10 wt.-% of a fibrous material, 1 to 20 wt.-% of a binder, 1 to 10 wt.-% of a thickener and 50 to 97.99 wt.-% of a solvent, and in which the fibrous material and the binder are present in a predetermined ratio in the range from 1:1 to 1:5. The present invention also relates to a method for filling joints in drywall constructions using such mixture, drywall constructions produced accordingly and the use of the sprayable mixtures described for reinforcing a drywall construction in the contact area between construction panels.

### CROSS-REFERENCE TO RELATED APPLICATION

This application is the United States national phase of International Application No. PCT/EP2021/000077 filed Jul. 2, 2021, the disclosure of which is hereby incorporated by reference in its entirety.

### BACKGROUND OF THE INVENTION

### Field of the Invention

The invention relates to a sprayable mixture for covering joints between building boards in drywall structures, wherein the mixture contains 0.01 to 10 wt.-% of a fibrous material, 1 to 20 wt.-% of a binder, 1 to 10 wt.-% of a thickener and 50 to 97.99 wt.-% of a solvent, and in which the fibrous material and the binder are present in a predetermined ratio in the range from 1:1 to 1:5. The present invention further relates to methods for filling joints in drywall constructions using such mixtures, correspondingly manufactured drywall constructions and the use of the sprayable mixtures to reinforce a drywall construction in the contact area between construction panels.

### Description of Related Art

In drywall construction, different types of panels are used to form interior walls and ceilings. Typically, the panels are used in the form of boards, which are attached against frame members, such as in known in the art as balloon frame assemblies. Examples include plasterboard coated with paper, also known as wallboard or drywall, paperless plasterboard made with fiber mats (e.g. fiberglass), and the like. These and other types of boards are typically cut to suitable dimensions and then attached to frame members, e.g. with screws, nails or the like to form wall sections which are formed from several boards.

Two panels lying next to each other, which are arranged in the same plane, form a connection seam or joint on vertical walls and horizontal ceilings. In the prior art, they are usually first filled with a filler and then covered with a joint reinforcement tape. Examples of joint reinforcement tapes that can be used and conventional methods for filling joints with such tapes are described, for example, in U.S. Pat. No. 2,850,404 or 6,668,897.

At corners, panels can meet at an angle. Here, reinforcement elements can be used to cover the corner seam and to protect the corner. The reinforcement element can be attached directly to the plate with fasteners, or a layer of joint compound can be applied under the cladding to attach the reinforcement element to the plate. The installed reinforcement is then covered over the cladding with several layers of joint compound. Fasteners that secure the panel to frame elements must also be covered with multiple layers of joint compound. After the various joint compound layers have been dried, the resulting surfaces can be sanded and painted to achieve the desired uniform and aesthetically pleasing appearance.

In gypsum drywall construction, paper tape is commonly used to bridge the seam between adjacent plasterboards. Alternatively, glass fiber tapes or other flat fiber structures can be used. To this purpose, the tape is embedded into the joint compound and then covered by at least one subsequent layer of joint compound to provide a uniform surface. The function of the tape in this construction is to bridge the neighboring panels, to give the connection strength and reinforcement against visible hairline cracks on the surface, which can form as a result of shrinkage and settlement when the construction is dried or as a result of mechanical stresses.

The introduction of the paper strip involves several repetitive steps, which makes the process relatively time-consuming. In addition, the subsequent spackling is highly demanding on the skill of the worker, because if the strip is improperly applied bubbles can occur, which often will become visible only after the joint has completely dried. In this case, a worker has to cut the tape from the joint and has to apply again a thin layer of joint com-pound and adhesive tape before he can continue with the next step.

Evidently, thus, the method used in the prior art is relatively complex and error prone.

WO 2017/044329 proposes a flexible adhesive composition for filling joints between plasterboard, which is formed from fibers, a binder of polymer resin, water, and a thickener. Instead of a filler, this adhesive composition is applied to the joint edge area between two panels and dried, so that the application of a joint reinforcement tape is no longer necessary. WO 2017/044329 claims that compared to conventional joint reinforcement tapes even better mechanical properties are achieved.

A disadvantage of the procedure in WO 2017/044329 is on the other hand, that due to the complete filling of the joints with the adhesive composition a relatively large amount of material is required, especially if the edges of the panels are not rectangular in the contact area. Further problematic are possible cracks in a surface coating (e.g. skim coat, paint) attached over the adhesive composition, which can form comparatively easily between the flexible adhesive and the surface coating. In addition, the described adhesive contains a relatively high proportion of binding agent, which, since the joint is to be completely filled with the adhesive mass, is also significant in terms of costs.

Against this background, there is a need for a system for joints between building boards, and in particular plasterboards, which, compared to conventional joint reinforcement tape, on the one hand one provides a comparable and preferably even improved stabilization of the joint, but which on the other hand avoids the difficulties in processing of such joint reinforcement tape. In addition, there is a need for a system in which the filling can be implemented using less material than is possible with the joint adhesive proposed in WO 2017/044329. The present invention addresses this need.

### SUMMARY OF THE INVENTION

In the studies underlying this application, it was surprisingly found that filling joints that are durable against deformation could be realized by means of a sprayable mixture, which comprises a fibrous material, a binder, a thickener and a solvent.

Accordingly, in a first aspect, the present invention relates to a sprayable mixture for covering joints between building boards in drywall constructions, which comprises 0.01 to 10 wt.-% of a fibrous material, 1 to 20 wt.-% of a binder, 1 to 10 wt.-% of a thickener and 50 to 97.99 wt.-% of a solvent. The fibrous material and the binder are present in the mixture in a ratio in the range from 1:1 to 1:5 and preferably from 1:3 to 1:5. This ratio ensures a sufficiently high amount of fibrous material in the dried mixture, which promotes optimal mechanical strength.

In the context of the invention described herein, contents in percent by weight in each case relate to the total weight of the composition described (for example, the sprayable mixture) unless something else is explicitly indicated.

A sprayable mixture provides the advantage that the mixture, after filling a joint with conventional filler, can e.g. be directly applied to the joint area by hand or mechanically by spraying, and after drying provides a joint reinforcement tape. Here, the thickness can be adjusted via the amount of the mixture or its solids content, so that the strength of the sprayed strip can be variably adjusted. Subsequently, the sprayed strip can be covered much like a conventional joint reinforcement tape with joint filler to thus form a reinforced joint filling. In the event of failure or breakage of the joint filler at the board joint, the sprayed-on joint tape forms a crack-bridging layer on the top layer of filler, so that visible cracks up to greater deformation or stress are avoided.

Compared to the joint adhesives described in WO 2017/044329, the sprayable mixture described herein is characterized by a generally lower solids content and a lower proportion of binding agent.

In addition to the above specifications for the sprayable mixture, it is preferred if the ratio of the fibrous material to the total amount of binder and thickener is in the range from 1:1 to 1:5.5 and preferably in the range from 1:3 to 1:5.

The sprayable mixture according to the present invention contains a fibrous material as a core component. Suitable fibers that can be used as the fibrous material include natural fibers, synthetic fibers or a combination of natural and synthetic fibers. Suitable synthetic fibers include, for example, acrylic, vinylon, DERCLON™, carbon, aramide, high density polyethylene, nylon, polyester, modacrylic, glass, metal, DYNEEMA™, polybenzimidazole, triacetate rayon, diacetate, Vinyon™, LYOCELL™, Acetate, polylactic acid, basalt, olefin, ORLON™, polyethylene, SARAN™, ZYLON™, Spandex and VECTRAN™ fibers. Suitable natural fibers that can be used include cellulose fibers, in particular in the form of microfibrillated cellulose fibers, vegetable fibers (for example cotton, coconut, or hemp), wood and animal fibers.

In one embodiment, a combination of different fibers can be used, for example a combination of polyethylene fibers with polypropylene fibers. In a particularly preferred embodiment, microfibrillated cellulose fibers are used as the fibrous material, either alone or in combination with another fibrous material. One advantage of microfibrillated cellulose fibers is an enhanced sprayability. Microfibrillated cellulose fibers which are also known as microcellulose, (cellulose) microfibrils, nanofibrillated cellulose, nanocel-lulose, or (cellulose) nanofibrils refer to cellulose fibers that have been defibrillated. This means that the individual microfibrils of the cellulosic fibers have been partially or completely separated from each other.

Preferred amounts of the fibrous material in the sprayable mixture are in the range from 0.1 to 8 wt.-%, in particular 1 to 5 wt.-% and particularly preferably in the range from 1.5 to 3.0 wt.-%.

Fibers of different sizes can be used in the fibrous material. In general, fibers with an average length of 0.0001 to 3 mm are suitable. The fibers preferably have a length in the range from about 0.0002 to about 1.5 mm. The diameter of the fibers may be variable, where preferably fibers with a diameter in the range from 5 μm to 25 μm and in particular 10 μm to 20 μm may be used. If microfibrillated fibres are used as fibers, the fibers may have an average fiber length in the range from 0.1 to 1500 μm, preferably in the range from 1 to 1500 μm, particularly preferably in the range from 500 to 1300 μm. Preferably, at least 15% by weight of the fibers are shorter than 200 μm. The diameter of the microfibrillated fibres may be in the range from about 5 and about 60 nm. The second relevant component of the sprayable mixture according to the invention is a binder, which is preferably a polymer binder, more preferably a water-miscible polymer binder. Polymer binder suitable in the context of the present invention include, for example, polyvinyl alcohol, ethylene vinyl acetate, styrene/acrylic polymers, acrylic polymers, polyurethane polymers, vinyl/acrylic polymers, and mixtures thereof, preferably polyvinyl alcohol.

The polymer binder can be any suitable film-forming polymer which can form a solid film or bind to pigments (e.g. from a filler). Suitable polymers include, in particular, polymers selected from vinyl acetates such as ethylene vinyl acetate and acrylates such as vinyl acrylates and styrenated acrylates. Useful polymers include acrylic polymers, vinyl acrylic polymers such as vinyl acetate-butyl acrylate copolymers, styrene acrylic polymers, and vinyl acetate polymers including vinyl acetate polymers sold under the tradenames UCAR® and NEOCAR® (The Dow Chemical Company, Midland, MI) such as UCAR® 367 brand latex adhesive; emulsion polymer products, including emulsion polymer products sold under the name VINREZ® (Hall-tech, Inc., Ontario, Canada); acrylic, vinyl acrylic, and styrene acrylic latex polymers, including those sold under the tradename AQUAMAC® (Hexion Specialty Chemicals, Columbus, OH). An exemplary vinyl acrylic polymer is TurCOR® 3025 from Celanese, which has a glass transition temperature of about 30° C. and contains 56% solids. Suitable functionalized acrylic polymers, alkyds, polyurethanes, polyesters and epoxies are also useful as polymer binder and can be obtained from a number of commercial sources. Useful acrylic paints are sold under the name ACRYLOID® (The Dow Chemi-cal Company, Midland, MI). Suitable epoxies are available under the trade-name EPON (Hexion Specialty Chemicals, Ohio); useful polyesters are sold under the tradename CYPLEX® (Cytec Industries, West Paterson, NJ); and usable vinyl polymers are available under the tradename UCAR™ (The Dow Chemical Company, Midland, MI).

Preferred amounts of the binder in the sprayable mixture are in the range from 5 to 15 wt.-%, in particular 6 to 12 wt.-% and particularly preferably in the range from 6 to 8 wt.-%.

Apart from the binder, the sprayable mixtures of the invention contain a thickener, by which the viscosity and the proper rheology is adjusted. Suitable thickeners are, for example, selected from starch, alkylhydroxypropylcelluloseether, hydroxypropyl methyl celluloses, xanthan gums, carboxymethylcelluloses, hydroxyethylcelluloses, sodium alginates and other salts of alginic acid, carrageenans, gum arabic, gum tragacanth, guar gum and its derivatives, locust bean gum, tamarind gum, psyllium seed gum, quince seed gum, larch gum, pectin and its derivatives, dextrans and hydroxypropylcelluloses. A particularly preferred thickener in the context of the present invention is starch, in particular in the form of pregelatinized wheat starch (commercially available for example as WEIGEL starch from Kröner-Stärke GmbH).

The thickener (or a mixture of several thickeners) is preferably present in the sprayable mixture according to the invention in a proportion of 1 to 5 wt.-%, in particular 1 to 3 wt.-% and more preferably 1.5 to 2.5 wt.-%.

The solvent may be water-based solvent. It may consist of at least a pre-dominant proportion (more than 50 wt.-%) of water, while the addition of organic solvents, for example alcohols such as ethanol, propanol or butanol, is tolerated for property adjustment. However, since such additives lead to odor concerns during processing and possibly also to undesirable evaporation in the long term, the addition of organic solvents should be kept to a minimum for the effect to be achieved. It is therefore preferred that the solvent consists of at least 70 wt.-%, more preferably at least 80 wt.-%, even more preferably at least 90 wt.-% and even more preferably at least 95 wt.-% of water. It is most preferred that only water is used as the solvent in the sprayable mixture.

Preferred amounts of the solvent in the sprayable mixture are in the range from 60 to 97 wt.-%, in particular more than 75 wt.-% to 97 wt.-% and particularly preferably in the range from 80 to 95 wt.-%.

To improve the stability of the sprayable mixture, the mixture can contain one or more preservatives and/or biocides, which is particularly useful when the composition is stored for longer times prior to its use. In principle, any preservative or biocide that is suitable for use in building boards, coatings or other products that are exposed to people and pets can be used in the sprayable mixture according to the invention.

Products that are suitable for use as preservatives and/or biocides in aque-ous environment are, for example, fungicides such as MERGAL® 174 (Troy Corp., Florham Park, NJ) or biocides such as pyrithione salts. Any water-soluble pyrithione salt with antimicrobial properties including, but not limited to, salts of 2-mercaptopyridine-N-oxide and of 1-hydroxypyridine-2-thione is useful. The sodium derivative of 2-mercaptopyridine-N-oxide, also known as sodium pyrithione, is a particularly suitable preservative in the context of the present invention.

Other preferred biocides are diidomethyl-4-tolylsulfone, thiabendazole, tebuconazole, 3-iodo-2-propynyl butyl carbamate, and combinations thereof. Another class of preferred preservatives are isothiazolines, in particular in the form of methylisothiazolinone, chloromethylisothiazolinone, benzisothiazolinone, octylisothiazolinone or dichloroctylisothiazolinone. The substances mentioned can each be used alone or as mixtures of several of the substances mentioned.

If the inventive sprayable mixture contains such preservatives and/or biocides, the amount thereof is limited to that necessary for the intended use time. The sprayable mixture preferably contains preservatives and/or biocides in a proportion in the range from 0.005 to 0.5 wt.-% and more preferably from 0.01 to 0.1 wt.-% of the mixture.

In addition to the aforementioned ingredients, the sprayable mixture may contain further optional ingredients, e.g. for property optimization or adjustment, which include, but are not limited to, humectants, defoamers, surfactants, colorants, pigments, fillers, dispersing agents or pH stabilizers.

A suitable dispersing agent is, for example, a multifunctional amine such as 2-amino-2-methyl-1-propanol. Humectants that can be used are sorbitol derivatives, polyhydric alcohols including, but not limited to, glycols such as ethylene glycol, diethylene glycol (DEG), triethylene glycol, propylene glycol, dipropylene glycol and/or tripropylene glycol, glycerin, or any combination thereof. Suitable agents for adjusting the pH include basic compounds such as ammonia, sodium hydroxide, triethylamine (TEA) or 2-amino-2-methyl-1-propanol (AMP). Suitable fillers and/or pigments include calcium carbonate, limestone, gypsum, nepheline syenite, titanium dioxide, lithophone, wollastonite, bismuth oxychloride, talc, clays and any mixtures thereof. A suitable defoamer is, for example, petroleum distillate.

In a preferred embodiment, the mixture according to the invention consists essentially of fibrous material, binder, thickener, solvents and optionally one or more preservatives (i.e. the proportion of other ingredients is at most 2 wt.-% and preferably at most 1 wt.-%). In another embodiment, the sprayable mixture according to the invention consists exclusively of fibrous material, binder, thickener, solvents and optionally one or more preservatives.

The sprayable mixture can be processed and sprayed with any suitable application system. Accordingly, in a further aspect the present invention relates to an application system with an output device, preferably in the form of a nozzle, a reservoir that is at least partially filled with a sprayable mixture as described above, and a transport mechanism, by which the sprayable mixture can be transported from the reservoir to the output device. The transport mechanism can be designed, for example, as a pipeline in combination with an overpressure container, via which the sprayable mixture is dispensed through the dispensing device when a triggering device is actuated as a result of pressure relief.

As explained above, the above described sprayable mixture can be used to fill and cover joints between building boards in a drywall construction. Accordingly, a further aspect of the present invention relates to a method for filling and covering joints between building panels in drywall constructions, the method comprising the steps:
providing a drywall construction with at least two building boards that are adjacent to one another via a joint,
filling the joint with a filler,
applying of a sprayable mixture containing 0.01 to 10 wt.-% of a fibrous material, 1 to 20 wt.-% of a binder, 1 to 10 wt.-% of a thickener and 50 to 97.99 wt.-% of a solvent on the area of the joint in such a way, that the sprayed-on material extends over the joint and over the area of the building boards adjoining it, and
drying the sprayable mixture.

The building boards may preferably be a plasterboard, paperless gypsum board, gypsum fiberboard or tile on the basis of plaster and/or cement. Most preferably, the building boards are plasterboard with or without a paper or cardboard coating.

The sprayable mixture used in the process is preferably a sprayable mixture as described in detail above.

The statement “in such a way that the sprayed material is over the joint and over the adjacent area of the building boards” is to be understood as meaning that the sprayed mixture is not only directly applied over the joint, but also extends over the adjacent areas of the building panels, so that preferably also areas of the building boards that were not covered with filler in step ii) are covered with the sprayable mixture.

The “joint” is not subject to any relevant restrictions with regard to the distance between the two building boards, i.e. the boards can directly adjoin and touch one another or the boards can be spaced apart from one another. In the case of a distance between the joints, the distance is preferably less than 10 mm and in particular less than 5 mm.

Depending e.g. on the concentration of the fibrous material and binder in the sprayable mixture, a single application of the mixture may not be sufficient to impart the desired strength to the construction. For the process, it can therefore be useful if the sprayable mixture is applied at least twice as part of the process. In general, there is no limit in how often the mixture may be applied.

In the investigations on which the invention is based, it has been found that favorable strengths can be achieved with a dry layer thickness of the applied sprayable mixture in the range from 200 to 800 μm. The sprayable mixture is therefore preferably applied up to a thickness of the dried mixture in the range from 200 to 800 μm, in particular from 350 to 700 μm and more preferably from 500 to 550 μm. This layer thickness can be achieved in one or more work steps.

After drying of the sprayable mixture the mixture may, for example, be covered with a further layer of surface coating to form a uniform background, e.g. for subsequent overpainting.

### DESCRIPTION OF THE INVENTION

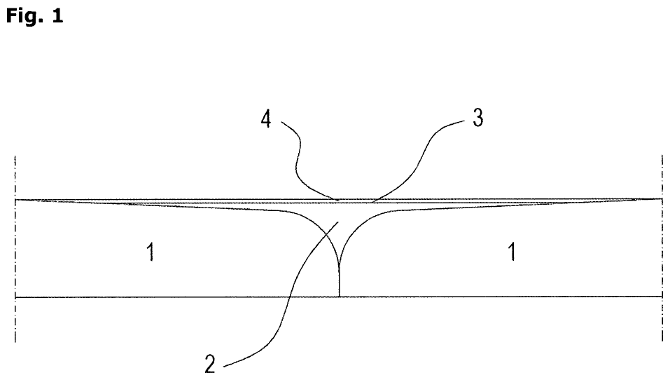

A still further aspect of the present invention relates to a drywall construction, which is obtainable according to a method as described above. Accordingly, the drywall construction comprises two building boards adjoining one another via a joint, the joint being filled with filler and covered with a sprayed and dried sprayable mixture. Such a drywall construction is shown by way of example in FIG. 1, in which 1 denotes the building boards (here plasterboard), 2 denotes the filler, 3 denotes the dried coating made from the mixture according to the invention (visible as line) and 4 denotes the surface coating.

The drywall construction has preferably a tensile strength (of the connection of structural panels, filler/grout filling and coating) of at least 100 N/mm, preferably at least 110 N/mm and more preferably at least 115 N/mm, wherein the tensile strength is determined in accordance with the DIN EN 13963, as specified in the example.

The drywall construction is preferably a wall or ceiling.

Finally, another aspect of the present invention relates to the use of a sprayable mixture, as specified in detail above, for reinforcing a drywall construction in the contact area between building boards and in particular plasterboards, wherein the sprayable mixture is applied to the contact area, which has optionally been leveled with a filler, and hardened by drying.

In the following, the invention is illustrated in more detail by means of exemplary embodiments, which, however, should not be construed as restricting the scope of protection of the application in any way.

### Example 1

A sprayable mixture according to the invention of the following ingredients was prepared by mixing the specified ingredients:

| | | |
|---|---|---|
| Microfibrillar cellulose (2% solution in water) | 3000 | parts |
| Agocel K825 F (Polyvinyl alcohol) | 225 | parts |
| Weigel starch (thickener) | 60 | parts |
| Biocide | 2.63 | parts |

In order to determine the properties of the mixture, films of various thick-nesses were produced (by spraying on several times followed by drying). The films were more than 8 cm wide. The films were then subjected to tensile tests in accordance with EN 13963:2014 by clamping the films vertically in a loading device. Subsequently, tensile stress applied was. The load up to break and the elongation at break of the film was determined for each of the samples. The values determined are given in the following Table 1:

| | Thickness of the | Tensile | Elongation |
|---|---|---|---|
| | applied mixture | strength | at break |
| | [mm] | [N] | [mm] |
| sample 1 (4 layers) | 0.24 | 42 | 0.23 |
| Sample 2 (6 layers) | 0.34 | 64 | 0.28 |
| Sample 3 (8 layers) | 0.54 | 74 | 0.76 |
| Kurt* | | 94 | 1.98 |
| Fiberglass fleece | | 44 | 0.52 |
| paper | | 71 | 0.96 |

*Joint tape from Knauf (reference system)

### Example 2

To determine the strength of joints processed with the mixture from Example 1, two pieces of a 12.5 mm thick plasterboard were cut to dimensions of 200 mm×300 mm according to EN 13963:2014 and connected over the long side in pairs. Gypsum plasterboard with HRAK (semicircular flattened longitudinal edge) and SKF (cut edge with bevel) 22.5° were used as gyp-sum boards for the tests. The boards were spaced at intervals of 0 and 3 mm, respectively.

The joint was closed on the back with a strip of adhesive tape and the front was filled with a Uniflott joint filler (Knauf Gips KG).

After that, at least two layers of the specified mixture were applied over the joint and dried, followed by surface coating and drying (7 days at 23±2° C., 50±5% relative humidity). Subsequently, the tape was removed and the test specimens were cut into test pieces with the dimensions 50 mm×400 mm. Each test piece was clamped vertically in a loader and a tensile load was steadily applied. The load up to the break (Fmax), the pull-out distance of the joint at break (dL (Fmax)) and the path to the first visible crack were determined from the samples. The mean of the values determined in each case for 5 measurements is given in the following table 2:

| Joint tape | Kurt | Sample 4 | Sample 5 | Sample 6 |
|---|---|---|---|---|
| Layer thickness dry | | 0.54 mm | 0.54 mm | 0.34 mm |
| Joint filler | Uniflott | Uniflott | Uniflott | Uniflott |
| Edge shape | HRAK | HRAK | HRAK | HRAK |
| Joint width | 3 mm | 3 mm | 3 mm | 3 mm |
| Fmax in N/mm | 112 | 111.7 | 123.8 | 115.8 |
| Path Fmax in mm | 0.24 | 0.57 | 0.44 | 0.27 |
| Distance to 1st | 0.32 | 0.6 | 0.6 | 0.5 |
| crack visible mm | | | | |
| | SKF 22.5° | SKF 22.5° | SKF 22.5° | SKF 22.5° |
| Edge shape | C. primed | C. primed | C. primed | C. primed |
| Joint width | 3 mm | 3 mm | 3 mm | 3 mm |
| Fmax in N/mm | 172.9 | 174.9 | 189.8 | 163.3 |
| Path Fmax in mm | 0.30 | 0.3 | 0.32 | 0.38 |
| Distance to 1st | 0.34 | 0.5 | 0.6 | 0.7 |
| crack visible mm | | | | |
| Edge shape | HRAK | HRAK | HRAK | HRAK |
| Joint width | 0 mm | 0 mm | 0 mm | 0 mm |
| Fmax in N/mm | 103.1 | 110.7 | 113.9 | 111.5 |
| Path Fmax in mm | 0.22 | 0.6 | 0.39 | 0.43 |
| Distance to 1st | 0.37 | 0.6 | 0.5 | 0.6 |
| crack visible mm | | | | |
| | SKF 22.5° | SKF 22.5° | SKF 22.5° | SKF 22.5° |
| Edge shape | C. primed | C. primed | C. primed | C. primed |
| Joint width | 0 mm | 0 mm | 0 mm | 0 mm |
| Fmax in N/mm | 84.6 | 109 | 117.8 | 104.4 |
| Path Fmax in mm | 0.33 | 0.28 | 0.18 | 0.2 |
| Distance to 1st | 0.39 | 0.7 | 0.4 | 0.3 |
| crack visible mm | | | | |

From the measured values it can be seen that a maximum breaking force Fmax could be achieved with all joint models, which was comparable or higher than with the reference system Kurt. Furthermore, the first cracks only appeared at longer paths, or the plasterboard failed beforehand.

1. A sprayable mixture for covering joints between building boards in drywall constructions, which contains 0.01 to 10 wt.-% of a fibrous material, 1 to 20 wt.-% of a binder, 1 to 10 wt.-% of a thickener and 50 to 97.99 wt.-% of a solvent, wherein the fibrous material and the binder is present in the mixture in a ratio in the range from 1:1 to 1:5.

2. The sprayable mixture according to claim 1, wherein the mixture contains fibrous material and (binder+thickener) in a ratio in the range from 1:1 to 1:5.5, preferably 1:3 to 1:5.

3. The sprayable mixture according to claim 1, wherein the mixture contains cellulose fibers as fibrous material, preferably in the form of microfibrillated cellulose fibers, synthetic polymer fibers, natural fibers or carbon fibers or a mixture of such fibers.

4. The sprayable mixture according to claim 1, wherein the mixture contains a water-miscible polymer binder as binder, preferably contains polyvinyl alcohol as the water-miscible polymer binder.

5. The sprayable mixture according to claim 1, wherein the mixture contains starch or a mixture of different starches as a thickener.

6. The sprayable mixture according to claim 1, wherein the mixture contains 0.1 to 8 wt.-%, preferably 1 to 5 wt.-% of fibrous material and/or 5 to 15 wt.-%, preferably 6 to 12 wt.-% binder, and/or 1 to 5 wt.-%, preferably 1 to 3 wt.-% thickener, and/or 60 to 97 wt.-%, preferably 80 to 95 wt.-% solvent.

7. The sprayable mixture according to claim 1, wherein the solvent is a water-based solvent and preferably consists of at least 70 wt.-%, preferably at least 90 wt.-% and more preferably at least 95 wt.-% of water.

8. The sprayable mixture according to claim 1, wherein the mixture further contains a preservative or a combination of preservatives, preferably in an amount of 0.005 to 0.5 wt.-% and more preferably in an amount of 0.01 to 0.1 wt.-%.

9. An application system with an output device, preferably in the form of a nozzle, a reservoir that is at least partially filled with a sprayable mixture in accordance with claim 1, and a transport mechanism by which the sprayable mixture can be transported form the reservoir to the output device.

10. A method for filling and covering joints between building boards, preferably plasterboards, in drywall constructions, the method comprising the steps:
providing a drywall construction with at least two building boards that are adjacent to one another via a joint,
filling the joint with a filler,
applying a sprayable mixture containing 0.01 to 10 wt.-% of a fibrous material, 1 to 20 wt.-% of a binder, 1 to 10 wt.-% of a thickener and 50 to 97.99 wt.-% of a solvent, or a mixture according to claim 1 on the area of the joint in such a way, that the sprayed material extends over the joint and over the area of the building boards adjoining it, and
drying the sprayable mixture

11. The method according to claim 10, wherein the sprayable mixture is applied within the scope of the method at least twice.

12. The method according to claim 10, wherein the sprayable mixture is applied up to a thickness of the dried mixture in the range of 200 to 800 μm, preferably 350 to 700 μm and more preferably 500 to 550 μm.

13. The method according to claim 10, wherein a layer of filler is applied to the resultant dried mixture.

14. A drywall construction, obtainable by a method according to claim 10.

15. The drywall construction according to claim 14, which has a tensile strength, determined based on DIN EN 13963, of at least 100 N/mm, preferably at least 110 N/mm and more preferably at least 115 N/mm.

16. A dry construction according to claim 14, which is a wall or ceiling.

17. (canceled)
